(19) United States
(12) Patent Application Publication
(10) Pub. No.: US 2002/0025449 A1
(43) Pub. Date: Feb. 28, 2002

(54) AN ELECTROACTIVE FILM ON A SUBSTRATE AND METHOD OF MAKING

(76) Inventors: JOHANES H. SUKAMTO, RICHLAND, WA (US); MARK F. BUEHLER, PORTLAND, OR (US); SCOT D. RASSAT, BENTON CITY, WA (US); RICK J. ORTH, KENNEWICK, WA (US); MICHAEL A. LILGA, RICHLAND, WA (US); RICHARD T. HALLEN, RICHLAND, WA (US)

Correspondence Address: STEPHEN R MAY K1-53, INTELLECTUAL PROPERTY SERVICES, BATTELLE MEMORIAL INSTITUTE, PACIFIC NORTHWEST DIVISION P O BOX 999-MSIN K1-53, RICHLAND, WA, 99352, US

(21) Appl. No.: 09/375,613

(22) Filed: Aug. 17, 1999

(51) Int. Cl. B32B 9/00; C25D 5/18; C25B 9/08; C25B 9/04

(52) U.S. Cl. 428/689; 205/316; 205/106; 205/108; 205/334; 205/198

(57) ABSTRACT

The electroactive product of the present invention is a metal cyanide film on a substrate, wherein the improvement is the metal cyanide film having a flux throughput capacity greater than 0.54 millicoulombs/second-cm² as measured by the specific cyclic voltammetry procedure. The improved metal cyanide film generally has a flux throughput capacity greater than that of unimproved metal cyanide film wherein the improved metal cyanide film was deposited at a slow rate. The present invention enjoys the advantages of greater cation equivalent loading capacity, and achieving ion separations using half the amount of electricity as other electrochemical ion separations.

This invention was made with Government support under Contract DE-AC0676RLO1830 awarded by the U.S. Department of Energy. The Government has certain rights in the invention.

### FIELD OF THE INVENTION

The present invention is an electroactive film on a substrate and methods of making.

As used herein, a specific cyclic voltammetry procedure for material characterization has the steps of placing a metalcyanometallate on a substrate in a 0.05 M K₂SO₄ solution at a scan rate of 50 millivolts/second between the applied potential of −0.1 and 0.8 volts vs. the saturated calomel reference electrode (SCE). The flux is calculated by dividing the total anodic charge passed by the exposed area and the average time to reach 95% fully loaded and 95% fully unloaded.

### BACKGROUND OF THE INVENTION

Separation of alkali metal ions from a solution of mixed ions is still one of the more difficult separations. Industrial applications range from synthesis of commodity chemicals to waste clean up. Wastes containing cesium (¹³⁷Cs) is of particular interest throughout the U.S. Department of Energy (DOE) complex. Potassium (K) separation from sodium (Na) is of interest to the forest products industry.

Presently, cesium may be extracted with conventional ion exchange as reported by Kurath, D E; Bray, L A; Brooks, K P; Brown, G N; Bryan, S A; Carlson, C D; Carson, K J; DesChane, J R; Elovich, R J; and Kim, A Y (1994) EXPERIMENTAL DATA AND ANALYSIS TO SUPPORT THE DESIGN OF AN ION-EXCHANGE PROCESS FOR THE TREATMENT OF HANFORD TANK WASTE SUPERNATANT LIQUIDS, PNNL-10187, Pacific Northwest National Laboratory, Richland, Wash. A disadvantage of conventional ion exchange is the large amount of secondary waste generated from the numerous process steps including acid elution, exchanger water rinse, and sodium loading of the exchanger. Another disadvantage is that neutralization of the acidic eluant adds sodium to the waste, which restricts the choice of waste form and limit the concentration of the waste in the waste form. Further, organic exchangers lose about 3% of their capacity per cycle. Therefore, a conventional ion exchanger can be used for only 20-30 cycles before becoming yet another secondary waste. A method to remove cesium from these streams without the production of significant liquid and solid wastes are being sought.

Aside from crystallization, there is no effective technology for separating K from Na. Although effective, crystallization technologies are typically energy intensive.

The general concept of using metal hexacyanometallates for separation of alkali cations has been demonstrated by Ikeshoji, THE SEPARATION OF ALKALI METAL IONS BY INTERCALATION INTO A PRUSSIAN BLUE ELECTRODE (1986) JES, Vol. 133, No. 10, 2108-2109. He showed a Prussian blue electrode was a selective ion-exchanger in which elution can be effected through a change in the oxidation state by changing the electrical current direction instead of a change in the solution type or pH.

Metal cyanides, or more specifically, transition metal hexacyanometallates, which have the general formula Mₙ^{A}M^{B}[M^{C}(CN)₆] where M^{A}, M^{B} and M^{C} are metals with different formal oxidation numbers or alkali metals, are known to be electroactive. They may contain ions other than metals and various amounts of water. Nickel ferrocyanide M₂^{A}[NiFe(CN)₆] and Prussian Blue soluble KFe[Fe(CN)₆] and insoluble Fe₄[(Fe(CN)₆)₃] are well known species of transition metal hexacyanometallates.

Nickel hexacyanoferrates (NiHCF), which is a subset of metal hexacyanometallates, exhibit selectivity for alkali ions in the order Cs>K>Na>lithium (Li). This has been demonstrated electrochemically by Bocarsly et al., EFFECTS OF SURFACE STRUCTURE ON ELECTRODE CHARGE TRANSFER PROPERTIES. INDUCTION OF ION SELECTIVITY AT THE CHEMICALLY DERIVATIZED INTERFACE, J. Electroanal. Chem., 140 (1982) 167-172. Furthermore, NiHCF and other hexacyanoferrates have been suggested for and used to selectively extract Cs, Harjula, R; Lehto J; Tusa E H and Paavola, A (1994) INDUSTRIAL SCALE REMOVAL OF CESIUM WITH HEXACYANOFERRATE EXCHANGER-PROCESS DEVELOPMENT. Nucl. Technol. 107, 272; Loos-Neskovic, C; Fedoroff, M and Revel, G (1976) USE OF RADIOISOTOPES FOR RETENTION STUDY ON NICKEL FERROCYANIDE, J. Radionanal. Chem. 30, 533; Prout, W E; Russel E R and Groh, H J (1965) ION EXCHANGE ABSORBTION OF CESIUM BY POTASSIUM HEXACYANOCOBALT(II)FERRATE(II) J. lnorg. Nucl. Chem. 27, 473.

In situ electrochemical preparation of NiHCF assures intimate contact between the NiHCF and the underlying current collector. This contact is necessary if the NiHCF is to be used in the manner suggested by Ikeshoji. However, these materials were made using nitrates as a supporting electrolyte and a constant applied potential. Constant applied potential means turning on a switch, whereupon potential increases from an initial potential to the applied potential and is kept at the applied potential for a period of time after which the switch is turned off. The flux capacity for NiHCF, prepared using published electrochemical methods, has a maximum of 0.52 millicoulombs/second-cm² and the equivalent loading capacity has a maximum of 83 nanomoles/cm² as measured by the specific cyclic voltammetry procedure. While these materials show the important characteristics of electrical reversibility and ion selectivity, their usefulness in separation processes is dependent on the maximum ion flux that can be sustained.

Thus, there is a need for a hexacyanometallate and method of making it that provides for a greater flux that would permit less area or volume of the hexacyanometallate and lower capital cost for a given application. In addition, there is a need for a method of preparing hexacyanometallate(s) that is/are stable in solution(s) having pH greater than 10.

### SUMMARY OF THE INVENTION

The electroactive product of the present invention is a metal cyanide film on a substrate, wherein the improvement is the metal cyanide film having a flux throughput capacity greater than 0.52 millicoulombs/second-cm² as measured by the specific cyclic voltammetry procedure. The improved metal cyanide film generally has a flux throughput capacity greater than that of unimproved metal cyanide film wherein the improved metal cyanide film was deposited at a slow rate. A further improvement was greater stability in solutions of high pH (pH>11) by addition of cesium. Longevity of operation of the metal cyanide was found to be enhanced with a perfluorinated ionomer (e.g. Nafion®) coating.

The method of the present invention is for making the electroactive film of metal cyanide on a conducting substrate. The method has the steps of

(a) placing the conducting substrate in a conducting solution of a film precursor with an electrolyte; and

(b) applying an electrical potential and thereby depositing the electroactive film; wherein the improvement comprises:

the depositing relies upon one or a combination of (1) the electrolyte a supporting electrolyte that is less oxidizing than nitrate, (2) the electrical potential is non-constant, (3) a temperature is less than room temperature.

In a preferred embodiment, the electrolyte is a supporting electrolyte that is less oxidizing than nitrate, and the electrical potential is non-constant.

Use of a potential waveform and less oxidizing supporting electrolyte favors formation of metal cyande(s) that is/are stoichiometric or near stoichiometric composition.

The metal cyanide film has a flux throughput capacity greater than 0.52 millicoulombs/second-cm² and an equivalent loading capacity larger than 83 nanomoles/cm² as measured by the specific cyclic voltammetry procedure, or has a flux throughput capacity greater than a metal cyanide film deposited by applying the final potential instantaneously with nitrates as supporting electrolytes measured by any flux throughput measurement method.

The present invention enjoys the advantages of greater flux throughput capacity and larger cation equivalent loading capacity, and thus achieving ion separations using half the area required using metal cyanide materials prepared under previous deposition procedures. A further advantage is improved stability in high pH solutions.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a cyclic voltammogram of a “literature” film in 0.05 M K₂SO₄.

FIG. 2 is a graph of current versus time for the “literature” film in 0.05 M K₂SO₄.

FIG. 3a is a graph of flux throughput versus loading capacity for the “literature” film in 0.05 M K₂SO₄.

FIG. 3b is a graph of flux throughput versus deposition time for the “literature” film in 0.05 M K₂SO₄.

FIG. 4 is a cyclic voltammogram of the film of the present invention.

FIG. 5 is a graph of flux throughput versus loading capacity for the film of the present invention.

FIG. 6 is a graph combining the data from FIG. 3 and FIG. 5.

FIG. 7a is a graph of atomic fraction of nickel versus depth comparing “literature” film with the film of the present invention.

FIG. 7b is a graph of atomic fraction of iron versus depth comparing “literature” film with the film of the present invention.

FIG. 7c is a graph of atomic ratio of Ni/Fe versus depth comparing “literature” film with the film of the present invention.

FIG. 7d is a graph of the average (of the data shown in FIG. 7c) atomic ratio of Ni/Fe versus depth comparing “literature” film with the film of the present invention.

FIG. 8 is the cyclic voltammograms of a “literature” film in a solution of 0.5 M Na₂SO₄ before and after exposure to 1 M NaOH.

FIG. 9 is the cyclic voltammograms of the film of the present invention before and after exposure to 1 M NaOH.

FIG. 10a is the cyclic voltammograms of a “literature” film in an ESP-simulant.

FIG. 10b is the cyclic voltammograms of the film of the present invention in an ESP-simulant.

FIG. 11a is the cyclic voltammograms of a “literature” film in an ESP solution.

FIG. 11b is the cyclic voltammograms of the film of the present invention in an ESP solution.

### DESCRIPTION OF THE PREFERRED EMBODIMENT(S)

Parameters that control film growth rate are (1) applied potential waveform (potential values and applied potential duration time), (2) deposition solution composition, and (3) temperature. According to a preferred embodiment of the present invention, a combination of the three parameters that results in the slowest growth rate yields a film with the best performance as defined by its mass flux throughput and ion loading capacity. As noted earlier, “literature” methods involve only the use of a single applied electrical potential for a specified time period; and, nitrate salts (potassium and sodium) as the supporting electrolyte. In contrast, the present invention manipulates the solution composition, applied potential waveform (potential values and applied potential duration time), temperature and combinations thereof to minimize the growth rate. Film preparation at temperatures below room temperature should result in films with enhanced performance compared to those prepared at room temperature.

The electroactive product of the present invention is a substrate with a metal cyanide film having a flux throughput capacity greater than previous metal cyanide films. The flux capacity of the metal cyanide film of the present invention is greater than 0.52 millicoulombs/second-cm² and the equivalent loading capacity is greater than 83 nanomoles/cm². It is preferred that the flux capacity of the metal cyanide film of the present invention be at least about a factor of 1.5 greater than for the metal cyanide film of the prior art.

The metal cyanide is preferably a metal hexacyanometallate. Metal (or transition metal) hexacyanometallates have the general formula Mₙ^{A}M^{B}[M^{C}(CN)₆] or Mₙ^{A}[M^{B}M^{C}(CN)₆] where M^{A}, M^{B} and M^{C} are metals with the same or different formal oxidation numbers. They may contain ions other than metals and various amounts of water. Nickel ferrocyanide M₂^{A}[NiFe(CN)₆] and Prussian Blue soluble KFe[Fe(CN)₆] and insoluble Fe₄[(Fe(CN)₆)₃] are well known species of transition metal hexacyanometallates. The M^{B} (metal) of the metal hexacyanometallate includes but is not limited to nickel, copper, silver, titanium, cobalt, zinc, iron, ruthenium, palladium. rhodium, gold, manganese and combinations thereof. The M^{C} (metallate metal) of the metal hexacyanometallate includes but is not limited to iron, chromium, manganese, cobalt, and combinations thereof.

The method of the present invention for making the electroactive film of the metal cyanide on a conducting substrate begins with placing the conducting substrate in a conducting solution of a film precursor with an electrolyte. Subsequently, an electrical potential is applied thereby depositing the electroactive film. The improved method according to the present invention uses a potential waveform wherein the electrolyte is a supporting electrolyte (e.g. sulfate) favoring slow growth or reduced deposition rate of the metal cyanide. This reduced deposition rate is achieved by using non-constant electrical potential in combination with a supporting electrolyte that is less oxidizing than nitrate salts, for example sulfate salts.

Non-constant electrical potential may be achieved in any of several ways including but not limited to intermittent, ramp, stepped, and combinations thereof. Intermittent refers to alternating on/off periods of a substantially constant electrical potential. Intermittent may also be described as alternately pausing at an initial potential and pausing at a final potential. Ramp refers to an increasing continuous electrical potential, specifically increasing from an initial potential to a final potential over a time of at least several seconds. Stepped refers to incremental (discontinuous) increase of electrical potential, or increasing from an initial potential to a final potential and pausing at at least one intermediate potential.

The reduced deposition rate maximizes formation of stoichiometric materials. The electroactive film is formed when metal ion generated at the electrode surface reacts with the hexacyanometallate anion to precipitate the metal hexacyanometallate film onto the surface of the conducting material. Use of the sulfate electrolyte reduces oxidation power of the conducting solution.

The cationic and monovalent anionic separation from a solution with mixed ions may be combined in a preferred method having the steps of:

(a) placing an anion membrane selective for monovalent anions over divalent anions into the solution;

(b) placing a cathode coated with an electroactive film of a metal cyanide into the solution;

(c) applying a cathodic potential to the cathode;

(d) absorbing a first cation onto the electroactive film and leaving a second alkali metal in the solution, and transporting the monovalent anions across the anion membrane into an anolyte stream.

The cations are typically alkali metals including but not limited to potassium and the monovalent anion includes chloride (Cl⁻).

In a process for cesium separation, loading of the film with cesium requires an applied potential of about 0.55V (SCE) or less and unloading must be conducted at 0.60V (SCE) or greater. Because sodium loading occurs at about 0.40V (SCE), it is possible that selectivity for cesium over sodium could be enhanced by applying the appropriate potential; thus, the applied potential could be used as an additional driving force to increase the Cs/Na separation factor.

The broad anodic peak with a smaller peak current for cesium compared to sodium suggests that unloading of cesium is slower than sodium unloading and that the films have higher affinity for cesium. Cations with less affinity for the film are expected to diffuse freely through the film as charge flows, resulting in sharp peaks in a cyclic voltammogram. High cation affinity causes ion flow to be hindered and cyclic voltammogram peaks to be broadened because of slow charge compensation within the film.

Use of nickel hexacyanoferrate films for cesium removal from tank wastes requires stability in highly basic media. Metal hexacyanoferrates are well-known to dissolve in strongly basic solutions to form nickel hydroxide and soluble hexacyanoferrate. However, nickel hexacyanoferrates containing cesium, such as Cs₂NiFe(CN)₆, are insoluble in up to 4 M NaOH solutions. According to the present invention, electroactive nickel hexacyanoferrate films containing cesium ion are stable for over two months in 1 M NaOH solutions containing 5 mM cesium ion. Application of a cathodic potential in the caustic solution results in ion uptake without significant film loss. However, without cesium in solution, the films degrade within two weeks, which is still substantially more stable than “literature” films. Apparently, the small amount of cesium in the solution sufficiently shifts the equilibrium to the insoluble cesium phases and away from the more soluble sodium phases. These results suggest that using nickel hexacyanoferrate films for cesium removal from highly basic tank wastes would most likely need to be combined with processes that reduce the pH of the solution (e.g., a salt-splitting process).

Equipment for Examples

A standard three-electrode system was used in the preparation and characterization of electroactive films. A saturated calomel (SCE) reference electrode was employed, and potentials are presented herein with respect to this standard. A large surface area (>20 cm²) platinum foil or mesh counter electrode was used in all electrochemical experiments. The reference and counter electrodes were located near (typically <2.5 cm from) the working electrode. All test solutions were sufficiently conductive (>0.1 M) such that ohmic losses in solution are negligible. Nickel hexacyanoferrate films were deposited on two types of nickel working electrodes. These electrodes are described below in conjunction with the specific experimental system used.

One working electrode was 99.98% pure nickel (Goodfellow). In one experimental embodiment, disks of 1.27 cm diameter were embedded in epoxy, polished and suspended in the test solution. In another experimental embodiment, a nickel plate was sealed to an electrochemical cell with an o-ring and a clamp providing an area exposed to the test solution of 1.90 cm diameter. Prior to each film deposition, 600 grit sandpaper was typically used to prepare the surface of the nickel disks. Nickel foils were etched in 1 M HNO₃ for 2 to 3 minutes. All electrodes were thoroughly rinsed prior to use.

Reagent-grade chemicals were used as purchased without further purification. All salt purities were >99%, with the cesium nitrate purity was better than 99.99%. Deionized water (18.2 MΩ-cm) was utilized in all salt solution preparations and for final rinsing of electrochemical cell components. Solutions were open to air at ambient temperature in all procedures.

Film characteristics were determined with cyclic voltammetry. Cyclic voltammetry was in the range −0.1 to 0.8V (SCE) in a solution of 1.0 M sodium nitrate (NaNO₃) or cesium nitrate (CsNO₃), 0.5 M sodium sulfate (Na₂SO₄), or 0.05 M potassium sulfate (K₂SO₄) at a scan rate of 50 mV/s. Cyclic voltammetry was typically started from an applied potential of 0.25V, scanning anodically to 0.8V, then cathodically to −0.1V, returning to 0.25V (SCE). Typically, current data were collected every 2 mV for each CV. Integration of either the anodic or cathodic cyclic voltammogram wave provides a measure of the film coverage and capacity for alkali ion loading. An EG&G Instruments Corp. (Princeton Applied Research) potentiostat/galvanostat model 273A or model 283 were connected to National Instruments general purpose interface bus (GPIB) interface boards in personal computers (PCs). Electrochemical experiments were controlled and data were acquired using LabVIEW (National Instruments) software run on the PCs.

Film composition was determined through Auger depth profiling using PHI 680 Auger Nanoprobes from Physical Electronics.

### EXAMPLE 1

An experiment was conducted to quantify the cation equivalent loading of an electroactive film (KNiFe(CN)₆) deposited by constant electrical potential (prior art) and compare it to the cation equivalent loading achieved with the slow-growth deposition method of the present invention.

Samples of nickel disk and nickel plate (foil) electrodes were coated with the electroactive film, specifically nickel hexacyanoferrate, using the “literature procedure” used in (1) Bocarsly, A B and Sinha, S: CHEMICALLY DERIVITIZED NICKEL SURFACES: SYNTHESIS OF A NEW CLASS OF STABLE ELECTRODE INTERFACES, J. Electroanal. Chem., 132 (1982) 157-162; and (2) Bocarsly, A B and Sinha, S EFFECTS OF SURFACE STRUCTURE ON ELECTRODE CHARGE TRANSFER PROPERTIES INDUCTION OF ION SELECTIVITY AT THE CHEMICALLY DERIVITIZED INTERFACE, J. Electroanal. Chem., 140 (1982) 167-172. Briefly, the nickel surface was oxidized (corroded) at an anodic potential of 0.6 to 1.8V for ˜1 to 30 min in a solution containing ferricyanide ion (e.g., 5-10 mM Fe(CN)₆³⁻) and a supporting electrolyte (e.g., 0.1 M KNO₃ or NaNO₃), (Sukamto, J P H; Rassat, S D; Orth, R J; Lilga, M A; Lawrence, W E; Surma, J E and Hallen, R T SEPARATIONS USING ELECTROACTIVE MATERIALS FOR DOE TANK WASTE APPLICATIONS, 1996).

To fairly compare the present invention to “literature” methods, supporting electrolytes with the same number of units of equivalent charge were used. Specifically, the use of 0.1 M KNO₃ is compared to the use of 0.05 M K₂SO₄. Comparison of the applied potential waveform is based only on the same final applied potential; that is, the same final potential is used for the “literature” films as the present invention. This leaves the applied potential duration time for the “literature” procedure unspecified. As shown below, a large range of applied potential duration times was examined, and it is shown that our data cover the best performing “literature” film.

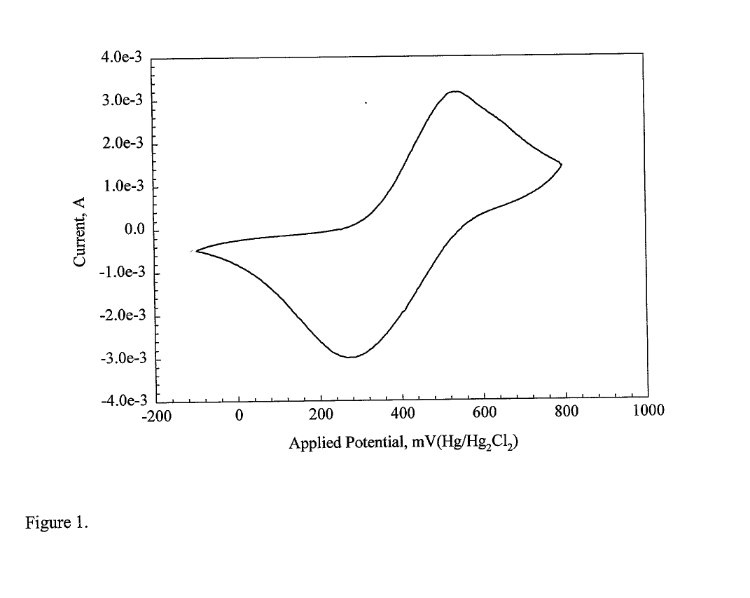

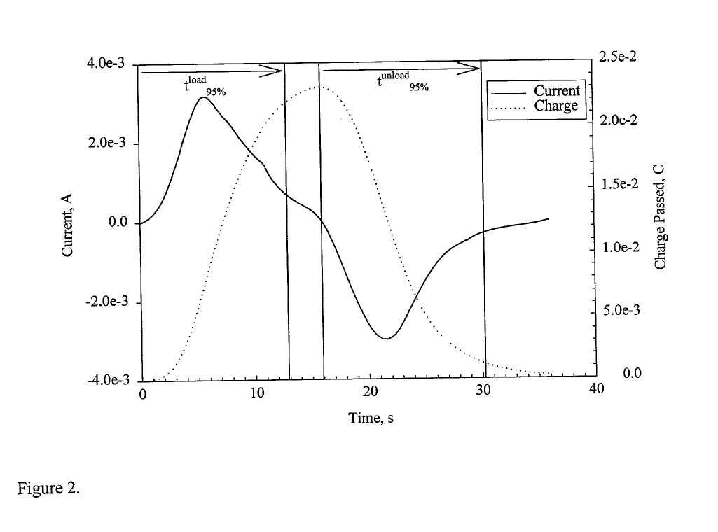

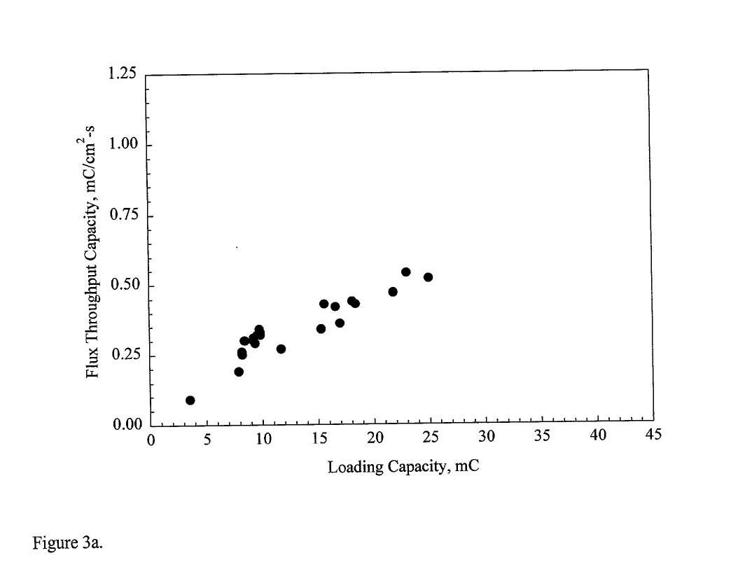

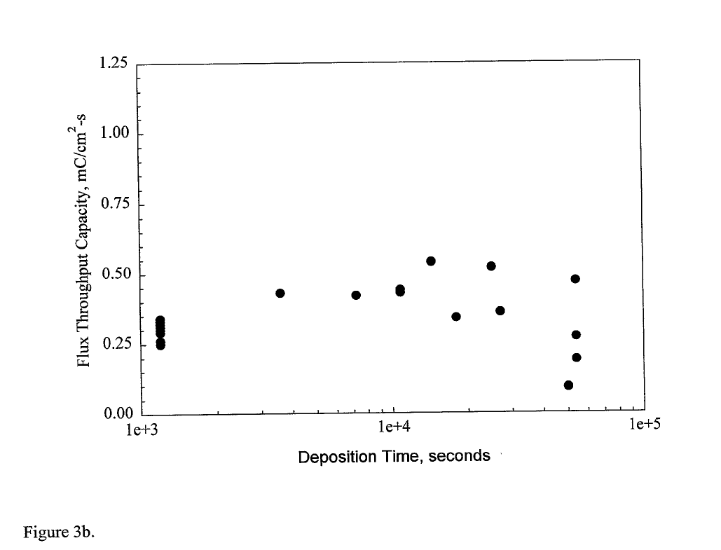

A typical cyclic voltammogram of a “literature” film in 0.05 M K₂SO₄, obtained using parameters given earlier is shown in FIG. 1, where the current measured is plotted as a function of the applied potential. The data shown in FIG. 1 are from the best “literature” film. An alternative presentation of the same data is to plot the measured current as a function of time, shown in FIG. 2. Integration of the current over time yields the loading capacity of the film; division of the loading capacity by the projected surface area yields the loading capacity per unit area; finally, the flux throughput can be obtained by dividing the loading capacity per unit surface area by the average of the time required for loading and unloading. For both loading and unloading times, the 95% times are used; these are defined in FIG. 2. The flux throughput of films prepared using the “literature” procedure is shown in FIG. 3a, 3b. The flux throughput is plotted as a function of the loading capacity in FIG. 3a. The flux throughput vs. deposition time is plotted in FIG. 3b. It is of particular interest to note that the “literature” film with the highest flux throughput (and loading capacity) did not require the longest preparation time. Therefore, increasing the deposition time beyond that shown in FIG. 3b is unlikely to produce films with flux throughput higher than those shown in FIG. 3b.

In contrast to the “literature” procedure, the present invention utilizes the solution composition and applied potential to control the film growth rate. In all methods, concurrent with NiHCF formation, as initiated by the corroding nickel surface in the presence of ferricyanide in the contacting solution, nickel oxide is also formed at the surface. According to the present invention, less oxidizing supporting electrolytes were used; for the results shown below, 0.05 M K₂SO₄ was used. Sulfates are less oxidizing than nitrates, and therefore, the corrosion rate of nickel in the former was less resulting in a slower NiHCF growth rate for a given potential waveform.

Two types of applied potential waveform were used: (1) linear potential steps in 1 mV increments starting at the rest potential (typically about 0.22 V(SCE)) or 0.3V(SCE) and increasing to 1V(SCE) at effective rates in the range of 2.5 to 200 μV/s; and, (2) linear potential steps in 50 mV increments starting at 0.3V(SCE) and increasing to I V(SCE), where each potential step was applied for from one to twenty periods of about 600 seconds each. Because of the nature of the potentiostat and the controlling software, the sample was at open circuit for a fraction of a second between each period. While these two types of waveform do not comprehensively represent all possible waveforms, they clearly illustrate some of the possible methods for preparing films in a slow growth mode (SGM) where the growth rate is controlled by the application of a non-constant potential.

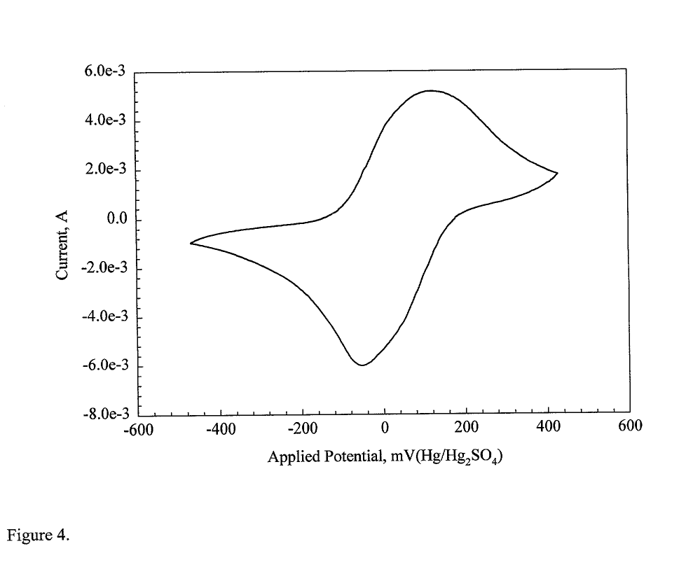

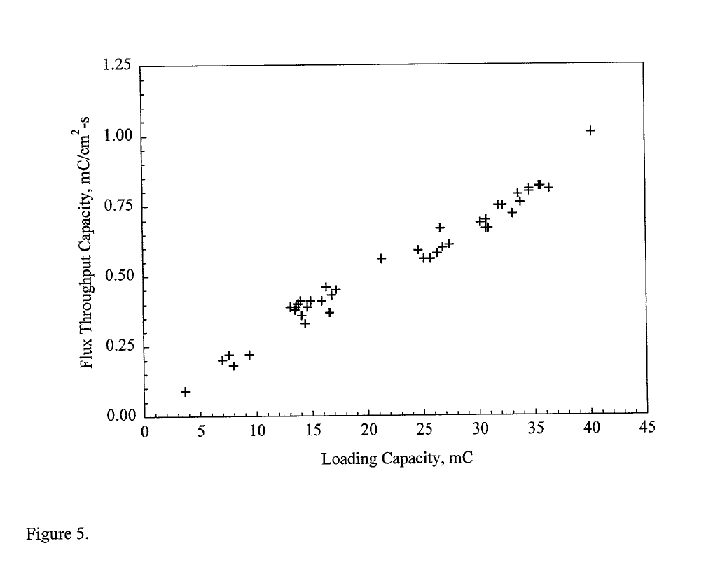

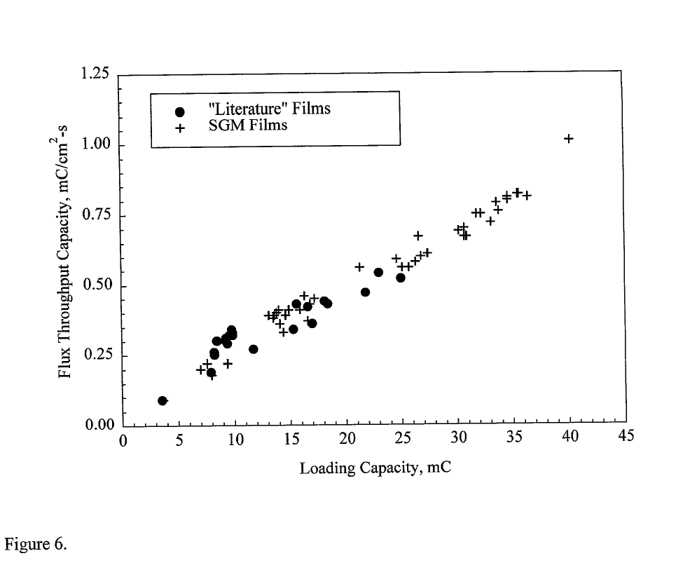

The enhanced performance of the slow growth films is demonstrated by cyclic voltammetry experiments. The cyclic voltammogram of the best SGM film is shown in FIG. 4. Comparison of the data shown in FIGS. 1 and 4 shows that the peak current of the SGM film is higher than that of the “literature” film. The higher peak current of the SGM film shows that (1) the SGM film has a higher flux throughput (the best SGM film had a flux throughput 1.94 times that of the best “literature” film) and (2) the SGM film has a higher loading capacity (the best SGM film had a loading capacity 1.61 times that of the best “literature” film). Analogous to the summary for “literature” films shown in FIG. 3, the summary for SGM films is shown in FIG. 5. Comparison of the data shown in FIGS. 3 and 5 (see FIG. 6) shows that SGM films with (1) higher loading capacities than than those of the literature films and (2) larger flux throughputs than those of the “literature” films are readily prepared.

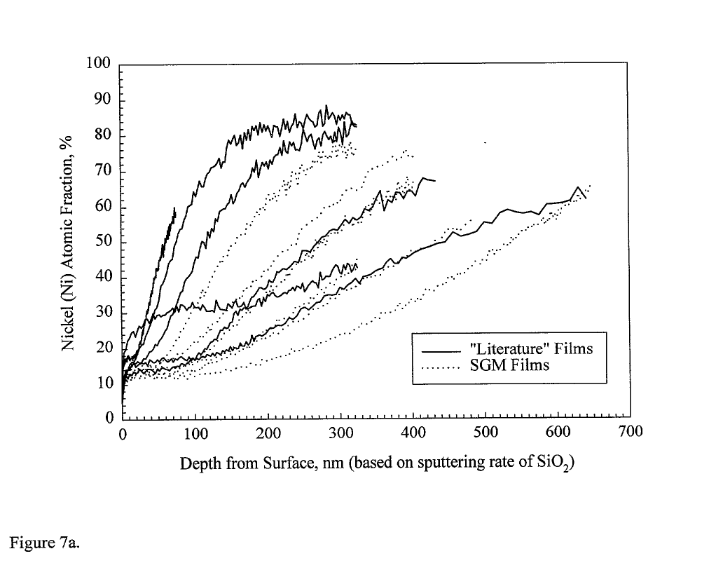

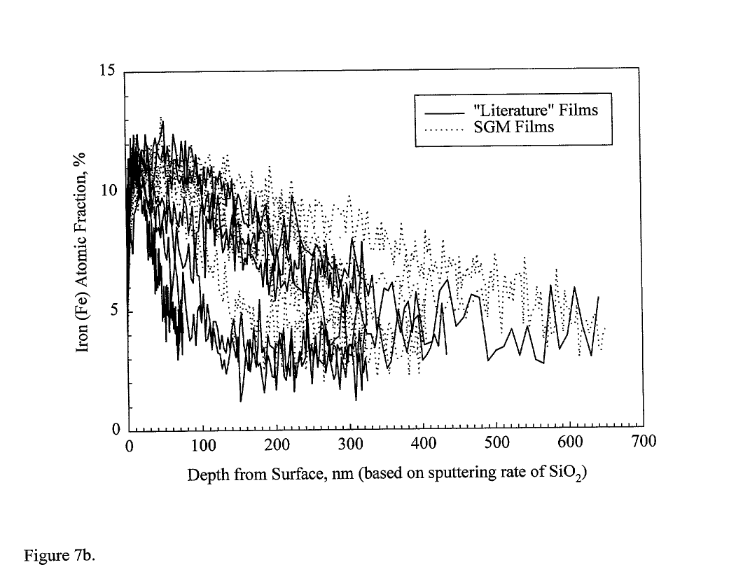

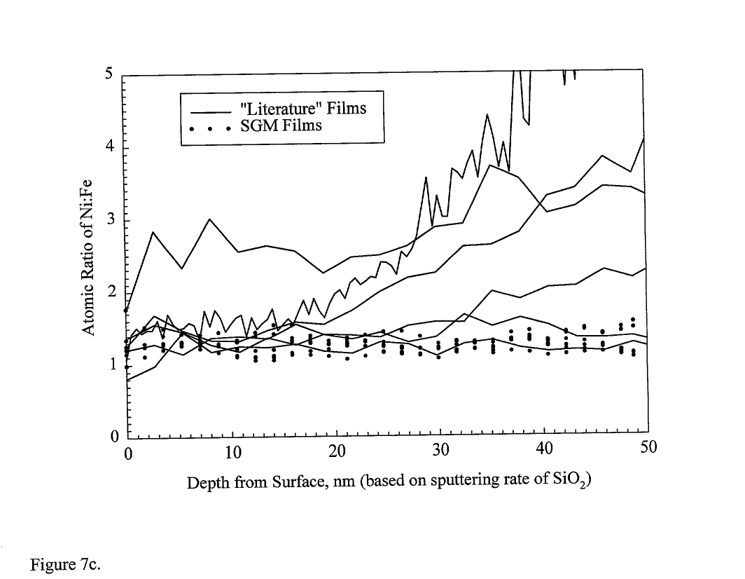

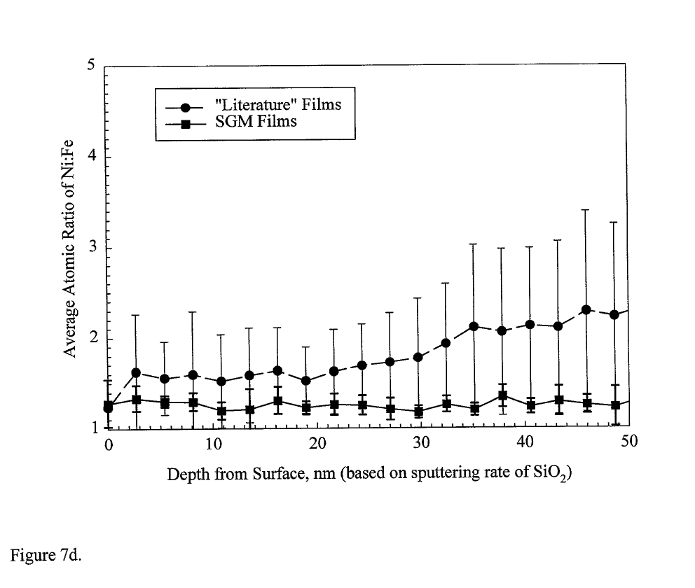

The composition of 3 representative “literature” and 3 representative SGM samples were determined by Auger depth profiling. The sputtering rate was approximately 5.4 nanometers/minute (based on the sputtering rate of SiO₂). Since the sputtering rate for NiHCF under these conditions is not known, the exact film thickness can not be determined. However, the relative thickness between the different types of films were obtained from the results. The atomic fraction of nickel, iron, and the atomic ratio of nickel to iron as a function of the film thickness are shown in FIGS. 7a to 7d. The composition at two different locations on each film was determined. The six compositions of the “literature” films are shown collectively as solid lines and the corresponding six compositions of the SGM films are shown as dotted lines. The data in FIG. 7a showed that the SGM films were in general thicker than the “literature” films. This observation is consistent with the higher loading capacity of the SGM films. The SGM films were also richer in Fe content as shown in FIG. 7b. Quantitatively, the SGM films ratio of Ni to Fe was more stoichiometric (Ni/Fe≅/=1) than that found in the “literature” films. FIG. 7c compares the atomic ratio of nickel and iron for “literature” film and the film of the present invention. The averages of the data shown in FIG. 7c are shown in FIG. 7d. Together, FIGS. 7c and 7d suggest that the SGM films are (1) more stoichiometric (the average of Ni:Fe is nearer to one) and (2) more uniform in composition (the error bars are smaller), which are correlated to the enhanced performance of the SGM films. It is believed that other preparation procedures that result in substantially stoichiometric ratio of Ni to Fe will yield materials of comparable performance as those produced in the present invention.

### EXAMPLE 2

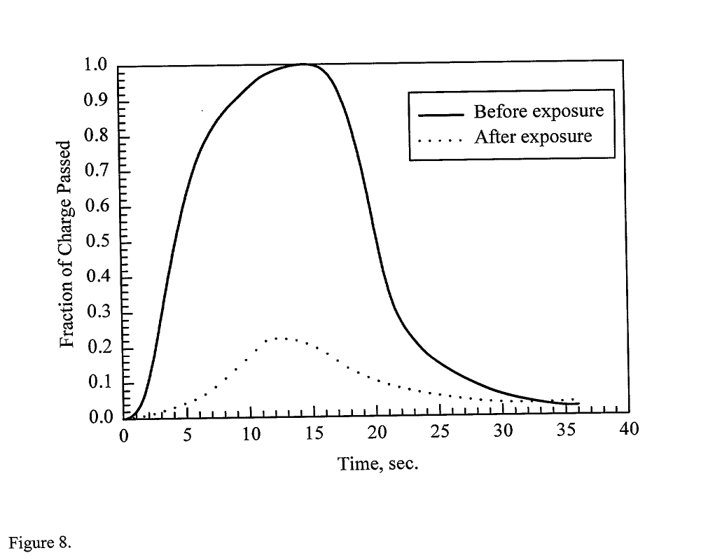

Stability of NiHCF in alkaline solutions is of interest since some of the Cs-containing waste streams have high pHs. The normalized charge passed vs. time plot of a “literature” film in a solution of 1 M NaNO₃ before and after exposure to 1 M NaOH are shown in FIG. 8. The data show that the “literature” NiHCF film degraded significantly after only 100 minutes of exposure (no potential cycling).

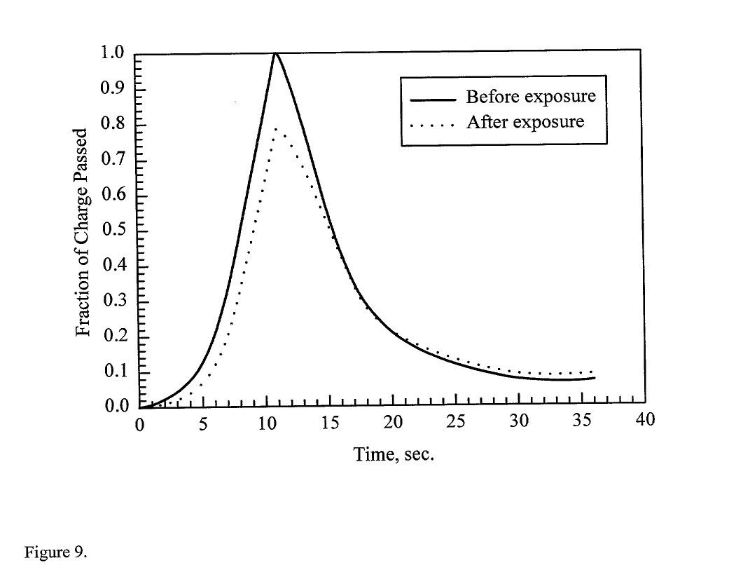

In the present invention, NiHCF films were prepared in a solution of potassium ferricyanide and cesium nitrate; cesium nitrate replaced potassium nitrate as the supporting electrolyte. The cyclic voltammograms of a typical film before and after exposure to 1 M NaOH are shown in FIG. 9. In contrast to the cyclic voltammogram of the “literature” film shown in FIG. 8, the data in FIG. 9 indicate that the film in the present invention is more stable in alkaline solutions since the film capacity after exposure to 1 M NaOH is nearly the same as that before exposure.

It is believed that use of cesium sulfate would enhance flux throughput without compromising the stability of the film.

### EXAMPLE 3

The ability of an electroactive ion exchange material to withstand the chemical process environment to which it will be exposed is of great interest. A target stream of interest for the application of ESIX in the forest products industry is an aqueous solution derived from the Electrostatic Precipitator (ESP) catch. While the literature indicates a range of ESP catch compositions, we used a typical composition containing only the major components of an actual pulp mill ESP catch matrix for the ESP simulant. The mass fractions and molar concentrations of the ions in this simulant dissolved in an excess of water are shown in Table E3-1. The target species for the cation-ESIX process is K⁺, which is about one-twelfth as concentrated as Na⁺.

TABLE E3-1
Composition of Electrostatic Precipitator Catch Simulant Solution.

| Species | Mass Fraction | Concentration (mol/L) |
|---|---|---|
| Na⁺ | 30.0 | 1.240 |
| K⁺ | 4.3 | 0.100 |
| SO₄²⁻ | 61.0 | 0.600 |
| Cl⁻ | 2.4 | 0.064 |
| CO₃²⁻ | 2.3 | 0.036 |

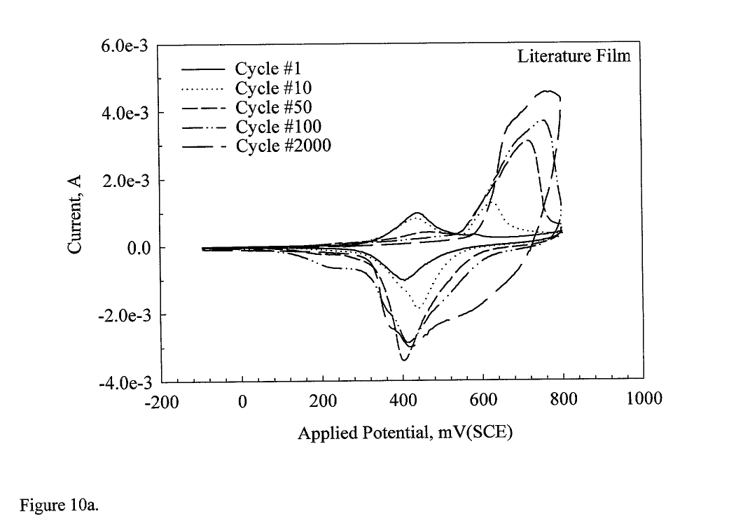

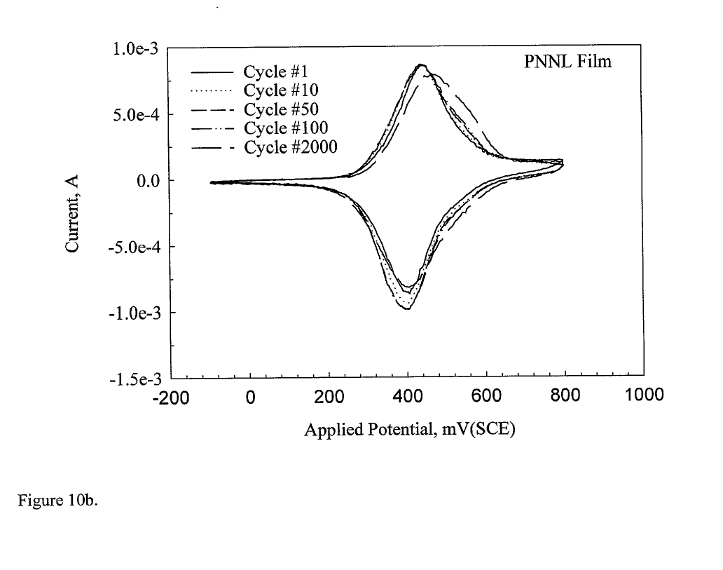

Changes in the CVs over many redox cycles are used to assess the chemical compatibility of the ESP catch solution and NiHCF film preparations. FIG. 10a shows CVs for a literature NiHCF film deposited on a nickel rod in contact with an ESP-simulant solution, and FIG. 10b depicts a similar experiment using an NiHCF film which has been coated with a perfluorinated ionomer (e.g., Nafion®). A typical evaporative coating procedure was used (e.g., see K. N. Thomsen and R. P. Baldwin, Analytical Chemistry, 61 (1989) 2594); 5% Nafion® was applied to the NiHCF electrode. After the solvent evaporated, a thin perfluorinated ionomer layer remained on the electrode. Changes in the literature film are clearly detected as early as the second redox cycle, where additional current peaks are noted near 590 mV on the anodic sweep and 475 mV on the cathodic. After more cycling, these new CV features increase in magnitude and shift in potential. At 50 cycles, the anodic portion of the CV in FIG. 10a indicates a residual peak near 450 mV, which may be attributed to the preferred NiHCF-alkali interactions. However, the new feature at higher potential dominates the anodic portion of the CV and renders the NiHCF-cation interaction indistinguishable in the cathodic sweep. With continued cycling, the CVs (e.g., cycle 2000 in FIG. 10a) bear no resemblance to the first few. The data suggest a rapid degradation of the literature film in the ESP-simulant solution during redox cycling, possibly as a result of the carbonate and the associated alkalinity of the solution (pH>10). The new features in the CVs are likely due to the formation and electroactivity of nickel hydroxide film at exposed regions of the nickel electrode substrate resulting from NiHCF film loss and/or conversion to the hydroxide form.

The comparable voltammetric experiments for a film of the present invention, shown in FIG. 10b, indicate vastly improved chemical stability in the ESP-simulant solution. The character of the voltammograms undergoes some transformation, however, and this is most clearly seen by comparing the CVs for cycles 2 and 2000. In particular, the peaks in the latter cycle are somewhat broadened and shifted to slightly higher potential. Assuming negligible composition changes in the bulk solution, the CV data suggest structural modifications within the film. The mechanism and implications of the modifications are not currently understood. The peak broadening may be the result of increased site-site repulsive interactions within the NiHCF or is perhaps directly due to the creation of some modified sites having slightly different formal potential.

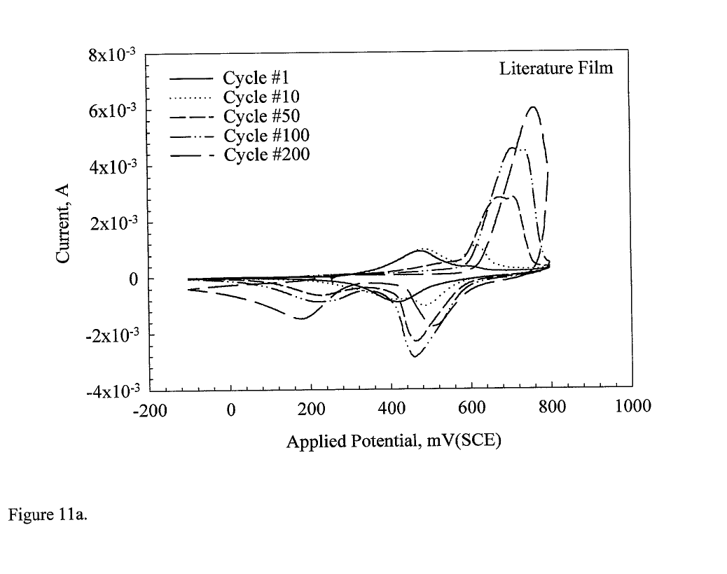

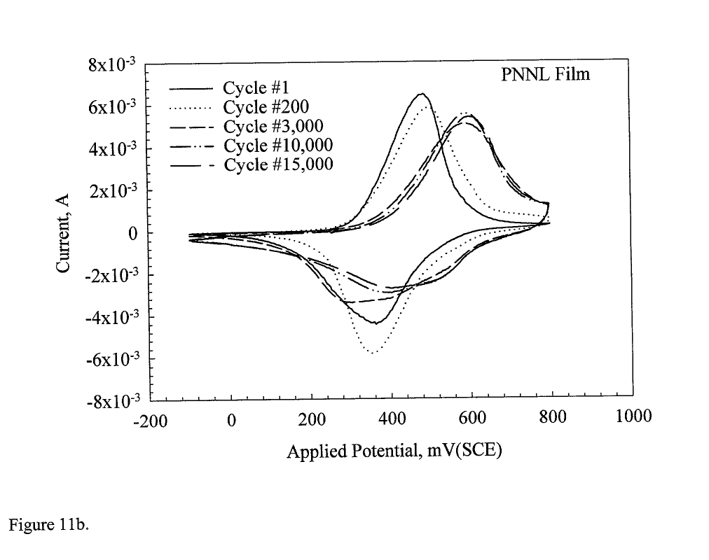

When an actual ESP solution (obtained from Weyerhaeuser) was used, similar results were obtained. The CVs of a literature NiHCF film in the ESP solution are shown in FIG. 11a. Immediate degradation of the film is clearly seen; the 200^{th} cycle shows no characteristics that are similar to the 2^{nd} cycle. On the other hand, CVs obtained for a film of the present invention in the same ESP solution show that the film is stable to at least 15,000 cycles (see FIG. 10b).

### CLOSURE

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. An electroactive product of a metal cyanide on an electrically conducting substrate, wherein the improvement comprises:
said metal cyanide has a flux throughput capacity greater than 0.52 millicoulombs/second-cm² as measured by a specific cyclic voltammetry procedure.

2. The electroactive product as recited in claim 1, wherein said metal cyanide is a metal hexacyanometallate.

3. The electroactive product as recited in claim 2, wherein the metal of said metal hexacyanometallate is selected from the group consisting of nickel, copper, silver, titanium, cobalt, zinc, iron, ruthenium, palladium, rhodium, gold, manganese, and combinations thereof.

4. The electroactive product as recited in claim 2, wherein the metallate of said metal hexacyanometallate is selected from the group consisting of iron, chromium, manganese, cobalt and combinations thereof.

5. The electroactive product as recited in claim 2, wherein said metal is nickel and said metallate is iron, further comprising cesium thereby resisting solubility in a basic solution.

6. The electroactive product as recited in claim 1, wherein said metal cyanide has a perfluorinated ionomer coating.

7. The electroactive product as recited in claim 1, further comprising cesium and exhibiting greater stability in a solution of high pH.

8. A method of making an electroactive film of a metal cyanide on a conducting substrate having the steps of:
(a) placing the conducting substrate in a conducting solution of a film precursor with an electrolyte;
(b) applying an electrical potential and thereby depositing said electroactive film from said film precursor;
wherein the improvement comprises:
said depositing selected from the group consisting of said electrolyte a supporting electrolyte that is less oxidizing than nitrate, said electrical potential is non-constant, a temperature is less than room temperature, and combinations thereof.

9. The method as recited in claim 8, wherein said electrical potential that is non-constant is selected from the group consisting of intermittent, ramp, stepped, and combinations thereof.

10. The method as recited in claim 8, wherein said intermittent is alternately pausing at an initial potential and pausing at a final potential.

11. The method as recited in claim 8, wherein said ramp is increasing from an initial potential to a final potential over a time of at least several seconds.

12. The method as recited in claim 8, wherein said stepped is increasing from an initial potential to a final potential and pausing at at least one intermediate potential.

13. The method as recited in claim 8, wherein said electrolyte is a sulfate thereby reducing an oxidation power of the conducting solution.

14. The method as recited in claim 8, wherein said metal cyanide is a metal hexacyanometallate.

15. The method as recited in claim 14, wherein the metal of said metal hexacyanometallate is selected from the group consisting of nickel, copper, silver, titanium, cobalt, zinc, iron, ruthenium, palladium, rhodium, gold, manganese, and combinations thereof.

16. The method as recited in claim 14, wherein the metallate of said metal hexacyanometallate is selected from the group consisting of iron, chromium, manganese, cobalt, and combinations thereof.

17. The method as recited in claim 8, further comprising the step of coating said metal cyanide with a perfluorinated ionomer.

18. The method as recited in claim 8, further comprising adding cesium and exhibiting greater stability in a solution of high pH.
